(19) United States
(12) Patent Application Publication
(10) Pub. No.: US 2020/0084711 A1
(43) Pub. Date: Mar. 12, 2020

(54) ACCESS PROCESSING METHOD, BASE STATION AND MOBILE COMMUNICATION TERMINAL

(71) Applicants: China Mobile Communication LTD., Research Institute, Beijing (CN); China Mobile Communications Corporation, Beijing (CN)

(72) Inventors: Liang Liu, Beijing (CN); Gang Li, Beijing (CN); Xiaodong Xu, Beijing (CN); Yami Chen, Beijing (CN); Guang Yang, Beijing (CN)

(21) Appl. No.: 16/466,782

(22) PCT Filed: Dec. 6, 2017
(86) PCT No.: PCT/CN2017/114792

§ 371 Date: Jun. 5, 2019

(30) Foreign Application Priority Data
Dec. 6, 2016 (CN) 201611110499.7

(51) Int. Cl. H04W 48/18

(52) U.S. Cl. CPC H04W 48/18; H04W 88/06

(57) ABSTRACT

The present disclosure provides an access processing method, a base station and a mobile communication terminal. The access processing method includes: receiving an access request carrying a target NAS message from a mobile communication terminal capable of being connected to a first network and a second network, the target NAS message including a first NAS message corresponding to the first network and/or a second NAS message corresponding to the second network; determining a target core network, the target core network being a core network to which the base station is capable of accessing among a first core network corresponding to the first network and a second core network corresponding to the second network; and transmitting the target NAS message to the target core network.

### CROSS-REFERENCE TO RELATED APPLICATION

The present application claims a priority of the Chinese patent application No. 201611110499.7 filed on Dec. 6, 2016, which is incorporated herein by reference in its entirety.

### TECHNICAL FIELD

The present disclosure relates to the field of mobile communication access technology, in particular to an access processing method, a base station and a mobile communication terminal.

### BACKGROUND

Mobile communication has profoundly changed our daily lives, and people have never stopped seeking for high-performance mobile communication. A 5^{th}-Generation (5G) mobile communication system has emerged, so as to meet the requirements on an explosive growth of mobile data traffic, the connection among a huge number of devices as well as the continuous appearance of new services and application scenarios.

International Telecommunication Union (ITU) has defined three typical application scenarios for the 5G mobile communication system, and formulated eight key abilities. How to meet the requirements on these scenarios and the key abilities has become a critical issue to the communication industry. Considering such factors as the requirements, a technical development trend and smooth evolution, there shall concurrently exist two routes for the 5G mobile communication system, i.e., new air interface and evolved air interface on the basis of a 4^{th}-Generation (4G) mobile communication system. Before the commercial use of the 5G mobile communication system, the 4G mobile communication system will evolve continuously so as to meet the increasing requirement on system capacity. Hence, the 4G mobile communication system and the 5G mobile communication system will coexist and interoperate within a long time period.

Considering the evolution of the 4G mobile communication system to the 5G mobile communication system in the related art, as shown in FIG. 1, a Long Term Evolution (LTE) evolved Node B (eNB) which accesses to an Evolved Packet Core (EPC) of the 4G mobile communication system needs to be concurrently connected to the EPC and a new core network of the 5G mobile communication system.

However, in terms of the evolution, a future mobile communication terminal needs to support the access to the EPC and the access to the 5G new core network simultaneously, and the LTE eNB and an evolved LTE (eLTE) eNB need to coexist too. Hence, there is an urgent need to provide a scheme to enable the mobile communication terminal to access to the EPC and the 5G new core network simultaneously.

### SUMMARY

An object of the present disclosure is to provide an access processing method, a base station and a mobile communication terminal, so as to enable the mobile communication terminal to access to different core networks via different types of base stations.

In one aspect, the present disclosure provides in some embodiments an access processing method for use in a base station, including: receiving an access request carrying a target Non-Access Stratum (NAS) message from a mobile communication terminal capable of being connected to a first network and a second network, the target NAS message including a first NAS message corresponding to the first network and/or a second NAS message corresponding to the second network; determining a target core network, the target core network being a core network to which the base station is capable of accessing among a first core network corresponding to the first network and a second core network corresponding to the second network; and transmitting the target NAS message to the target core network.

In another aspect, the present disclosure provides in some embodiments an access processing method for use in a mobile communication terminal capable of being connected to a first network and a second network, including: selecting a target NAS message, the target NAS message including a first NAS message corresponding to the first network and/or a second NAS message corresponding to the second network; transmitting an access request carrying the target NAS message to a base station, so that the base station transmits the target NAS message to a target core network, the target core network being a core network to which the base station is capable of accessing among a first core network corresponding to the first network and a second core network corresponding to the second network; and receiving a response message from the target core network through the base station.

In yet another aspect, the present disclosure provides in some embodiments a base station, including: a first reception module configured to receive an access request carrying a target NAS message from a mobile communication terminal capable of being connected to a first network and a second network, the target NAS message including a first NAS message corresponding to the first network and/or a second NAS message corresponding to the second network; a first selection module configured to determine a target core network, the target core network being a core network to which the base station is capable of accessing among a first core network corresponding to the first network and a second core network corresponding to the second network; and a first transmission module configured to transmit the target NAS message to the target core network.

In still yet another aspect, the present disclosure provides in some embodiments a mobile communication terminal capable of being connected to a first network and a second network, including: a second selection module configured to select a target NAS message, the target NAS message including a first NAS message corresponding to the first network and/or a second NAS message corresponding to the second network; a fourth transmission module configured to transmit an access request carrying the target NAS message to a base station, so that the base station transmits the target NAS message to a target core network, the target core network being a core network to which the base station is capable of accessing among a first core network corresponding to the first network and a second core network corresponding to the second network; and a third reception module configured to receive a response message from the target core network through the base station.

In still yet another aspect, the present disclosure provides in some embodiments a base station, including a processor, a transceiver and a memory. The processor is configured to read a program stored in the memory, so as to: receive an access request carrying a target NAS message from a mobile communication terminal capable of being connected to a first network and a second network, the target NAS message including a first NAS message corresponding to the first network and/or a second NAS message corresponding to the second network; determine a target core network, the target core network being a core network to which the base station is capable of accessing among a first core network corresponding to the first network and a second core network corresponding to the second network; and transmit the target NAS message to the target core network. The transceiver is configured to receive and transmit data. The memory is configured to store therein data for the operation of the processor.

In still yet another aspect, the present disclosure provides in some embodiments a mobile communication terminal capable of being connected to a first network and a second network, including a processor, a transceiver and a memory. The processor is configured to read a program stored in the memory, so as to: select a target NAS message, the target NAS message including a first NAS message corresponding to the first network and/or a second NAS message corresponding to the second network; transmit an access request carrying the target NAS message to a base station, so that the base station transmits the target NAS message to a target core network, the target core network being a core network to which the base station is capable of accessing among a first core network corresponding to the first network and a second core network corresponding to the second network; and receive a response message from the target core network through the base station. The transceiver is configured to receive and transmit data. The memory is configured to store therein data for the operation of the processor.

In still yet another aspect, the present disclosure provides in some embodiments a non-transitory computer-readable storage medium storing therein a computer-readable instruction capable of being executed by a processor. The computer-readable instruction is executed by the processor so as to: receive an access request carrying a target NAS message from a mobile communication terminal capable of being connected to a first network and a second network, the target NAS message including a first NAS message corresponding to the first network and/or a second NAS message corresponding to the second network; determine a target core network, the target core network being a core network to which the base station is capable of accessing among a first core network corresponding to the first network and a second core network corresponding to the second network; and transmit the target NAS message to the target core network.

In still yet another aspect, the present disclosure provides in some embodiments a non-transitory computer-readable storage medium storing therein a computer-readable instruction capable of being executed by a processor. The computer-readable instruction is executed by the processor so as to: select a target NAS message, the target NAS message including a first NAS message corresponding to the first network and/or a second NAS message corresponding to the second network; transmit an access request carrying the target NAS message to a base station, so that the base station transmits the target NAS message to a target core network, the target core network being a core network to which the base station is capable of accessing among a first core network corresponding to the first network and a second core network corresponding to the second network; and receive a response message from the target core network through the base station.

According to the embodiments of the present disclosure, upon the receipt of the access request carrying the target NAS message from the mobile communication terminal capable of being connected to the first network and the second network simultaneously, the base station may transmit the target NAS message to the target core network to which the base station is connected, and the target core network may determine whether the mobile communication terminal is allowed to be connected to the target core network in accordance with the target NAS message. As a result, it is able for the mobile communication terminal capable of being connected to various core networks to access to the core network through different base stations, thereby to provide services to a user.

### BRIEF DESCRIPTION OF THE DRAWINGS

FIG. 1 is a schematic view showing an eLTE eNB evolved from an LTE eNB and connected to an EPC and a 5G new core network in the related art;

FIG. 2 is a flow chart of an access processing method according to some embodiments of the present disclosure;

FIG. 3 is another flow chart of the access processing method according to some embodiments of the present disclosure;

FIG. 4 is yet another flow chart of the access processing method according to some embodiments of the present disclosure;

FIG. 5 is still yet another flow chart of the access processing method according to some embodiments of the present disclosure;

FIG. 6 is a flow chart of an access processing method according to some embodiments of the present disclosure;

FIG. 7 is another flow chart of the access processing method according to some embodiments of the present disclosure;

FIG. 8 is yet another flow chart of the access processing method according to some embodiments of the present disclosure;

FIG. 9 is still yet another flow chart of the access processing method according to some embodiments of the present disclosure;

FIG. 10 is still yet another flow chart of the access processing method according to some embodiments of the present disclosure;

FIG. 11 is a schematic view showing a base station according to some embodiments of the present disclosure;

FIG. 12 is a schematic view showing a mobile communication terminal according to some embodiments of the present disclosure;

FIG. 13 is schematic view showing an access procedure where network information is carried in an access request according to some embodiments of the present disclosure; and

FIG. 14 is a schematic view showing an access procedure where an NAS message and an identifier of the NAS message are carried in the access request according to some embodiments of the present disclosure.

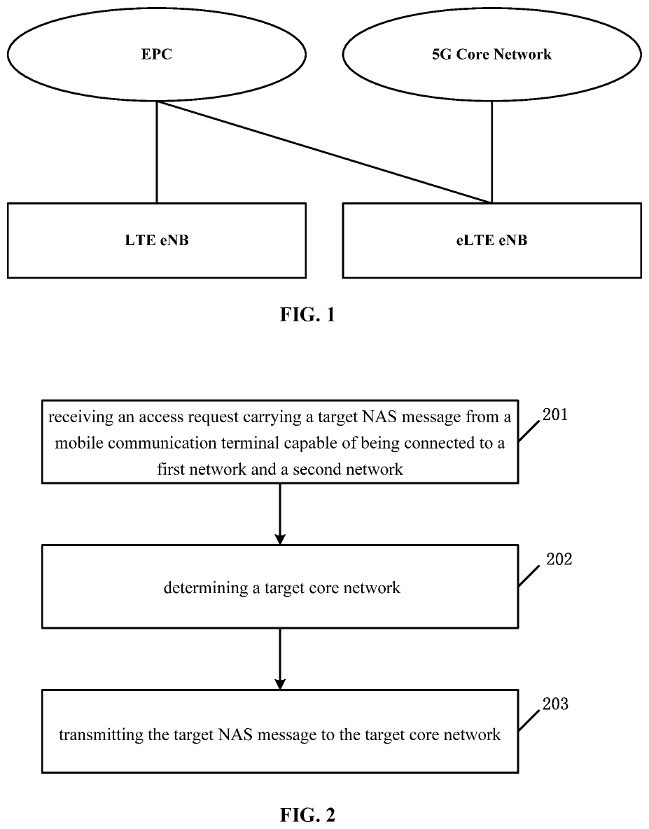

### DETAILED DESCRIPTION OF THE EMBODIMENTS

According to the embodiments of the present disclosure, upon the receipt of an access request carrying a target NAS message from a mobile communication terminal capable of being connected to a first network and a second network simultaneously, a base station may transmit the target NAS message to a target core network to which the base station is connected, and the target core network may determine whether the mobile communication terminal is allowed to be connected to the target core network in accordance with the target NAS message. As a result, it is able for the mobile communication terminal capable of being connected to various core networks to access to the core network through different base stations, thereby to provide services to a user.

The present disclosure provides in some embodiments an access processing method for use in a base station which, as shown in FIG. 2, includes: Step 201 of receiving an access request carrying a target NAS message from a mobile communication terminal capable of being connected to a first network and a second network, the target NAS message including a first NAS message corresponding to the first network and/or a second NAS message corresponding to the second network; Step 202 of determining a target core network, the target core network being a core network to which the base station is capable of accessing among a first core network corresponding to the first network and a second core network corresponding to the second network; and Step 203 of transmitting the target NAS message to the target core network.

In some embodiments of the present disclosure, upon the receipt of the access request carrying the target NAS message (e.g., the first NAS message corresponding to the first network, the second NAS message corresponding to the second network, or both) from the mobile communication terminal capable of being connected to the first network and the second network simultaneously, the base station may transmit the target NAS message to the target core network to which the base station is connected, and the target core network may determine whether the mobile communication terminal is allowed to be connected to the target core network in accordance with the target NAS message. On the basis of the above procedure, the mobile communication terminal capable of being connected to various core networks may access to the core network through different base stations, and thereby the code network may determine whether the mobile communication terminal is allowed to access to the core network.

In some embodiments of the present disclosure, the target NAS message may include one of the first NAS message and the second NAS message, or both. The NAS message, which belongs to an NAS, is unknown to a base station which belongs to an access stratum. Hence, a network corresponding to the target core network determined by the base station may probably be different from a network corresponding to the target NAS message. In this case, the target core network may reject the access of the mobile communication terminal thereto. In order to enable the mobile communication terminal to access to an appropriate core network, in a possible embodiment of the present disclosure, an access rejection message may be fed back to the mobile communication terminal, so as to notify the mobile communication terminal to re-initiate an access procedure in accordance with a new NAS message.

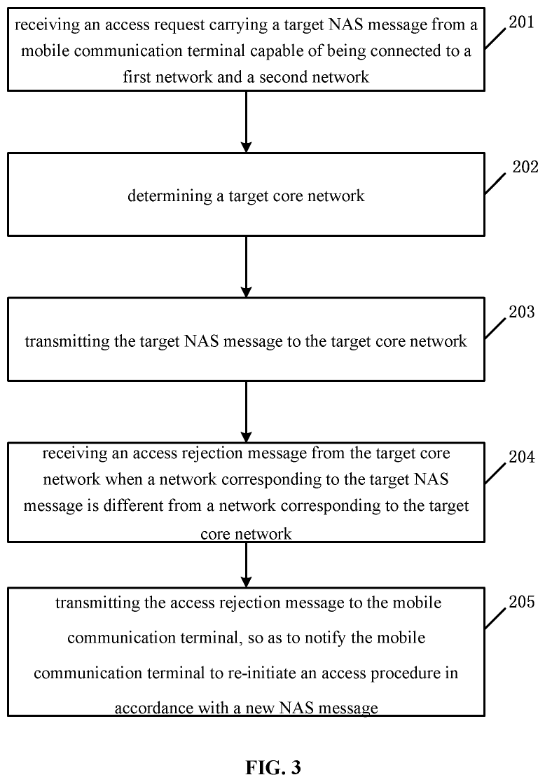

As shown in FIG. 3, the present disclosure further provides in some embodiments an access processing method which includes: Step 201 of receiving an access request carrying a target NAS message from a mobile communication terminal capable of being connected to a first network and a second network, the target NAS message including a first NAS message corresponding to the first network and/or a second NAS message corresponding to the second network; Step 202 of determining a target core network, the target core network being a core network to which the base station is capable of accessing among a first core network corresponding to the first network and a second core network corresponding to the second network; Step 203 of transmitting the target NAS message to the target core network; Step 204 of receiving an access rejection message from the target core network when a network corresponding to the target NAS message is different from a network corresponding to the target core network; and Step 205 of transmitting the access rejection message to the mobile communication terminal, so as to notify the mobile communication terminal to re-initiate an access procedure in accordance with a new NAS message.

According to the access processing method in the embodiments of the present disclosure, when the network corresponding to the target core network determined by the base station is different from the network corresponding to the target NAS message (i.e., there is NAS mismatching), the base station may forward the access rejection message from the target core network to the mobile communication terminal, so that the mobile communication terminal may select the new NAS message to re-initiate the access procedure. As a result, it is able for the mobile communication terminal to access to the target core network.

Detailed description will be illustratively given as follows.

When the second NAS message corresponding to the second network is carried in the access request from the mobile communication terminal and the target core network selected by the base station corresponds to the first core network corresponding to the first network (because the base station is merely capable of being connected to the first core network corresponding to the first network, or the base station, which is capable of being connected to the first core network and the second core network simultaneously, selects the first core network in accordance with a selection policy), i.e., when the first network corresponding to the target core network determined by the base station is different from the second network corresponding to the target NAS message, the first core network may reject the access of the mobile communication terminal thereto.

Upon the receipt of the access rejection message, the mobile communication terminal may re-transmit the access request carrying the first NAS message corresponding to the first network. At this time, the first network corresponding to the target core network determined by the base station may be the same as the first network corresponding to the target NAS message, so it is able for the mobile communication terminal to access to the first core network, thereby to provide services to the user.

According to the embodiments of the present disclosure, when the network corresponding to the target core network determined by the base station is different from the network corresponding to the target NAS message, the mobile communication terminal may re-initiate the access procedure in accordance with the new NAS message. As a result, it is able for the mobile communication terminal to access to an appropriate core network, thereby to provide services to the user.

It is found from the above-mentioned procedures that, multiple access procedures may occur and thereby an access speed may be reduced. One circumstance for an access failure lies in that the base station is merely capable of being connected to one core network and the network corresponding to the NAS message from the mobile communication terminal is different from the network corresponding to the only core network to which the base station is capable of being connected.

Hence, in some embodiments of the present disclosure, in order to prevent the occurrence of access failure due to the above reason, the base station may notify the mobile communication terminal of network information about a network corresponding to the core network to which the base station is capable of being connected, so that the mobile communication terminal is capable of selecting the NAS message corresponding to the network during the initiation of the access procedure.

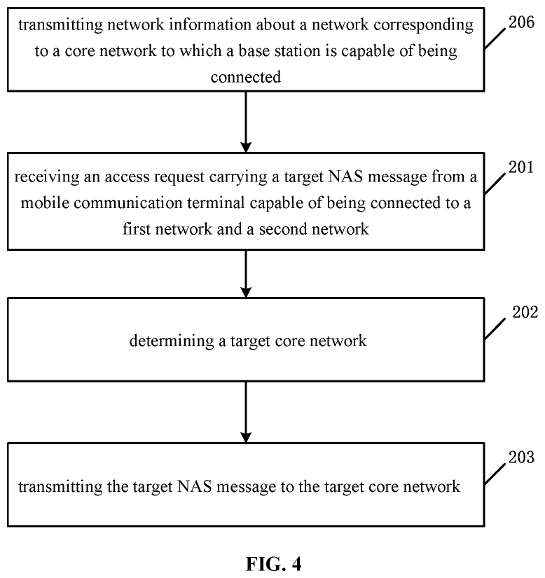

As shown in FIG. 4, the present disclosure further provides in some embodiments an access processing method which includes: Step 206 of transmitting network information about a network corresponding to a core network to which a base station is capable of being connected; Step 201 of receiving an access request carrying a target NAS message from a mobile communication terminal capable of being connected to a first network and a second network, the target NAS message being an NAS message selected by the mobile communication terminal for the network corresponding to the core network to which the base station is capable of being connected from a first NAS message and a second NAS message in accordance with the network information; Step 202 of determining a target core network, the target core network being a core network to which the base station is capable of accessing among a first core network corresponding to the first network and a second core network corresponding to the second network; and Step 203 of transmitting the target NAS message to the target core network.

In some embodiments of the present disclosure, the base station may notify in advance the mobile communication terminal of the network information about the network corresponding to the core network to which the base station is capable of being connected, so as to enable the mobile communication terminal to select the NAS message corresponding to the network. As a result, it is able to prevent the re-access procedure caused when the network corresponding to the only core network to which the base station is capable of being connected is different from the network corresponding to the target NAS message, thereby to accelerate the access.

When the base station is merely capable of being connected to the first core network and the mobile communication terminal has been notified of this fact, the mobile communication terminal may merely initiate the access procedure in accordance with the NAS message corresponding to the first network rather than the NAS message corresponding to the second network, and vice versa.

It is found from the above-mentioned procedures that, when the target NAS message and the target core network are selected randomly, a re-access procedure may occur, especially in another circumstance where the base station is capable of being connected to the first core network and the second core network simultaneously but the network corresponding to the core network selected by the base station in accordance with a selection policy is different from the network corresponding to the target NAS message.

In order to solve the above problem, in some embodiments of the present disclosure, a network identify of a the network corresponding to the target NAS message may be carried in the access request, so as to enable the base station to select a matched core network (i.e., enable the network corresponding to the core network to be the same as the network corresponding to the NAS message), thereby to prevent the occurrence of access failure.

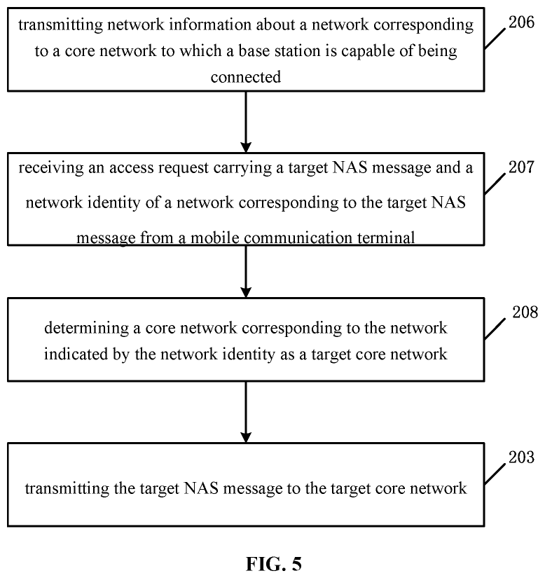

As shown in FIG. 5, the present disclosure further provides in some embodiments an access processing method which includes: Step 206 of transmitting network information about a network corresponding to a core network to which a base station is capable of being connected; Step 207 of receiving an access request carrying a target NAS message and a network identity of a network corresponding to the target NAS message from a mobile communication terminal capable of being connected to a first network and a second network, the target NAS message being an NAS message selected by the mobile communication terminal for the network corresponding to the core network to which the base station is capable of being connected from a first NAS message and a second NAS message in accordance with the network information; Step 208 of determining a core network corresponding to the network indicated by the network identity as a target core network; and Step 203 of transmitting the target NAS message to the target core network.

According to the embodiments of the present disclosure, the base station may notify in advance the mobile communication terminal of the network information about the network corresponding to the core network to which the base station is capable of being connected, so as to enable the mobile communication terminal to select the NAS message for the network corresponding to the core network to which the base station is capable of being connected. As a result, it is able to prevent the re-access procedure caused when the network corresponding to the only core network to which the base station is capable of being connected is different from the network corresponding to the target NAS message, thereby to accelerate the access. In addition, the network identity of the network corresponding to the target NAS message is carried in the access request, so the target core network determined by the base station may be the same as the network corresponding to the target NAS message. As a result, it is able for the mobile communication terminal to access to the core network through a single access procedure, thereby to accelerate the access.

In some embodiments of the present disclosure, the network information about the network corresponding to the core network to which the base station is capable of being connected may be transmitted through a system information block (SIB) or radio resource control (RRC) signaling.

Corresponding to the method for use in the base station, the present disclosure further provides in some embodiments an access processing method for use in the mobile communication terminal.

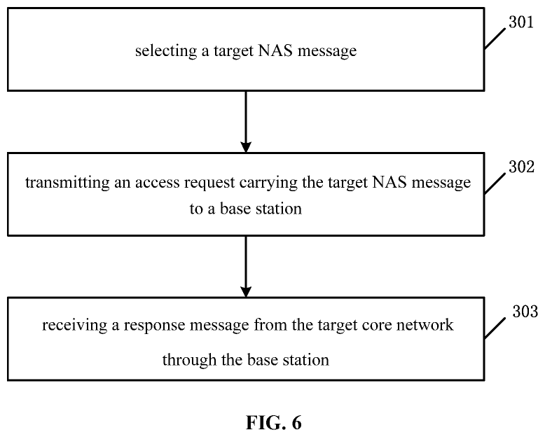

As shown in FIG. 6, the present disclosure further provides in some embodiments an access processing method for use in a mobile communication terminal capable of being connected to a first network and a second network, which includes: Step 301 of selecting a target NAS message, the target NAS message including a first NAS message corresponding to the first network and/or a second NAS message corresponding to the second network; Step 302 of transmitting an access request carrying the target NAS message to a base station, so that the base station transmits the target NAS message to a target core network, the target core network being a core network to which the base station is capable of accessing among a first core network corresponding to the first network and a second core network corresponding to the second network; and Step 303 of receiving a response message from the target core network through the base station.

According to the embodiments of the present disclosure, upon the receipt of the access request carrying the target NAS message (e.g., the first NAS message corresponding to the first network, the second NAS message corresponding to the second network, or both) from the mobile communication terminal capable of being connected to the first network and the second network simultaneously, the base station may transmit the target NAS message to the target core network to which the base station is connected, and the target core network may determine whether the mobile communication terminal is allowed to be connected to the target core network in accordance with the target NAS message. On the basis of the above procedure, the mobile communication terminal capable of being connected to various core networks may access to the core network through different base stations, and thereby the code network may determine whether the mobile communication terminal is allowed to access to the core network.

In some embodiments of the present disclosure, the target NAS message may include one of the first NAS message and the second NAS message, or both. The NAS message, which belongs to an NAS, is unknown to a base station which belongs to an access stratum. Hence, a network corresponding to the target core network determined by the base station may probably be different from a network corresponding to the target NAS message. In this case, the target core network may reject the access of the mobile communication terminal thereto. In order to enable the mobile communication terminal to access to an appropriate core network, in a possible embodiment of the present disclosure, the mobile communication terminal may re-initiate an access procedure in accordance with a new NAS message upon the receipt of an access rejection message.

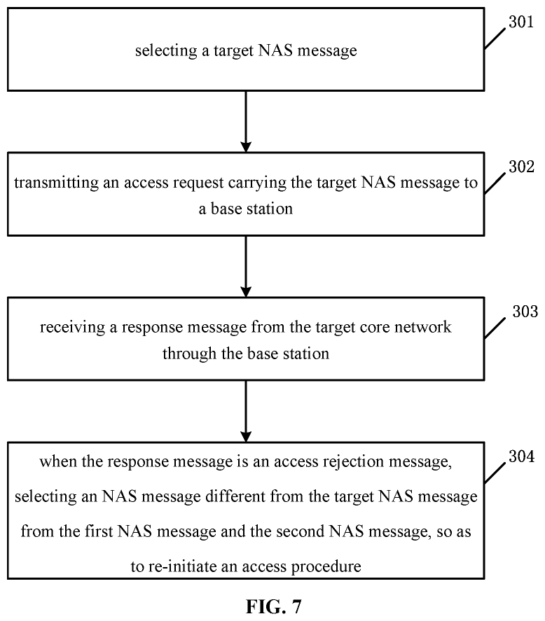

As shown in FIG. 7, the present disclosure further provides in some embodiments an access processing method which includes: Step 301 of selecting a target NAS message, the target NAS message including a first NAS message corresponding to the first network and/or a second NAS message corresponding to the second network; Step 302 of transmitting an access request carrying the target NAS message to a base station, so that the base station transmits the target NAS message to a target core network, the target core network being a core network to which the base station is capable of accessing among a first core network corresponding to the first network and a second core network corresponding to the second network; Step 303 of receiving a response message from the target core network through the base station; and Step 304 of, when the response message is an access rejection message indicating that a network corresponding to the target NAS message is different from a network corresponding to the target core network, selecting an NAS message different from the target NAS message from the first NAS message and the second NAS message, so as to re-initiate an access procedure.

According to the access processing method in the embodiments of the present disclosure, when the network corresponding to the target core network determined by the base station is different from the network corresponding to the target NAS message (i.e., there is NAS mismatching), the base station may forward the access rejection message from the target core network to the mobile communication terminal, so that the mobile communication terminal may re-initiate the access procedure. As a result, it is able for the mobile communication terminal to access to the target core network.

Identically, in order to solve the problems in the re-access procedure, the following improvements will be provided with respect to the two circumstances where the access failure occurs.

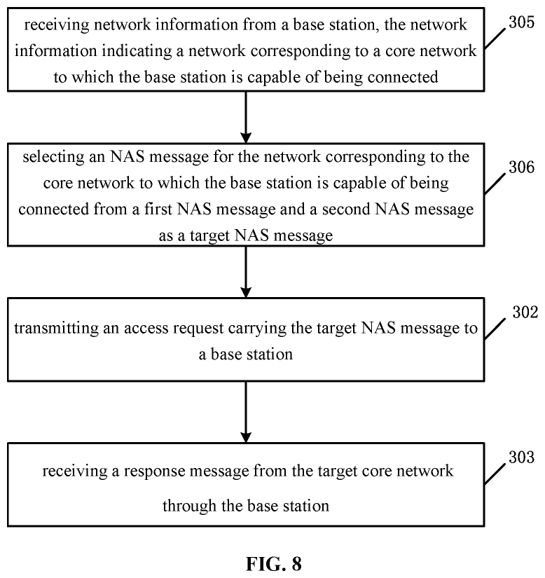

As shown in FIG. 8, the present disclosure provides in some embodiments an access processing method which includes: Step 305 of receiving network information from a base station, the network information indicating a network corresponding to a core network to which the base station is capable of being connected; Step 306 of selecting an NAS message for the network corresponding to the core network to which the base station is capable of being connected from a first NAS message and a second NAS message as a target NAS message in accordance with the network information; Step 302 of transmitting an access request carrying the target NAS message to the base station, so that the base station transmits the target NAS message to a target core network, the target core network being a core network to which the base station is capable of accessing among a first core network corresponding to the first network and a second core network corresponding to the second network; and Step 303 of receiving a response message from the target core network through the base station.

According to the embodiments of the present disclosure, the base station may notify in advance the mobile communication terminal of the network information about the network corresponding to the core network to which the base station is capable of being connected, so as to enable the mobile communication terminal to select the NAS message corresponding to the network. As a result, it is able to prevent the re-access procedure caused when the network corresponding to the only core network to which the base station is capable of being connected is different from the network corresponding to the target NAS message, thereby to accelerate the access.

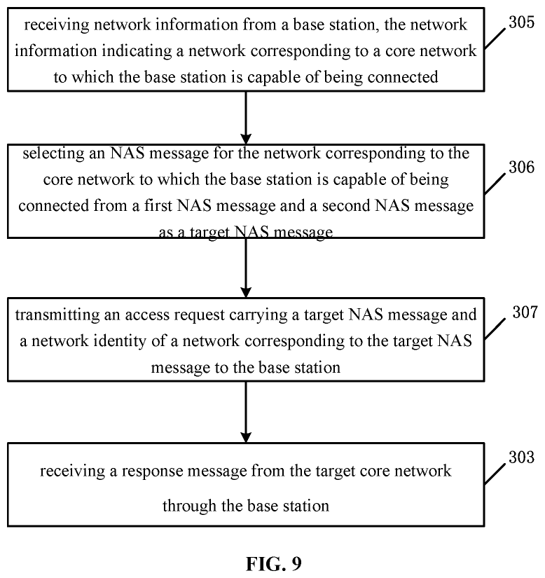

The present disclosure further provides in some embodiments an access processing method which, as shown in FIG. 9, includes: Step 305 of receiving network information from a base station, the network information indicating a network corresponding to a core network to which the base station is capable of being connected; Step 306 of selecting an NAS message for the network corresponding to the core network to which the base station is capable of being connected from a first NAS message and a second NAS message as a target NAS message in accordance with the network information; Step 307 of transmitting an access request carrying a target NAS message and a network identity of a network corresponding to the target NAS message to the base station, so that the base station transmits the target NAS message to a target core network, the target core network being a core network corresponding to the network indicated by the network identity; and Step 303 of receiving a response message from the target core network through the base station.

According to the embodiments of the present disclosure, the base station may notify in advance the mobile communication terminal of the network information about the network corresponding to the core network to which the base station is capable of being connected, so as to enable the mobile communication terminal to select the NAS message for the network corresponding to the core network to which the base station is capable of being connected. As a result, it is able to prevent the re-access procedure caused when the network corresponding to the only core network to which the base station is capable of being connected is different from the network corresponding to the target NAS message, thereby to accelerate the access. In addition, the network identity of the network corresponding to the target NAS message is carried in the access request, so the target core network determined by the base station may be the same as the network corresponding to the target NAS message. As a result, it is able for the mobile communication terminal to access to the core network through a single access procedure, thereby to accelerate the access.

In the step of receiving the network information from the base station, the network information may be received through an SIB or RRC signaling.

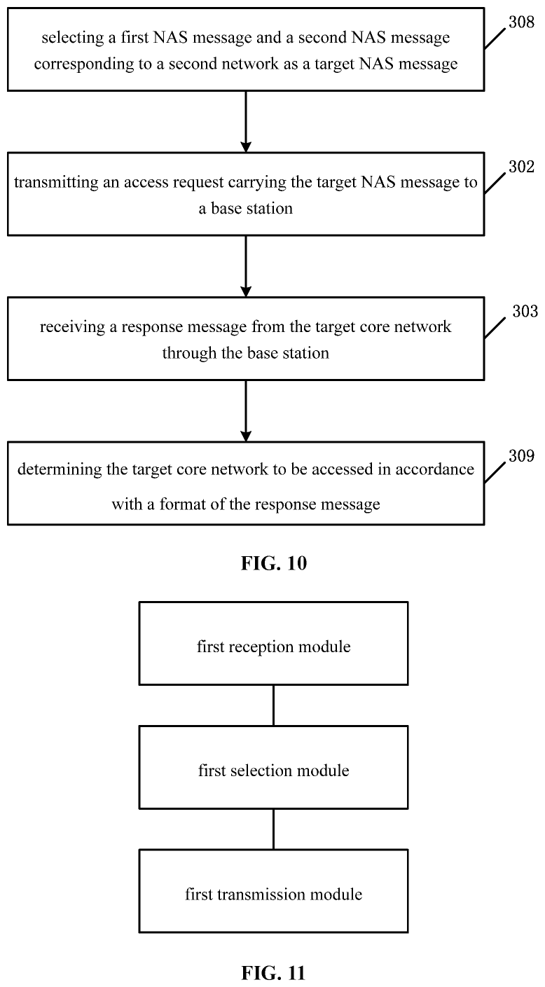

In order to prevent the re-access procedure, the present disclosure further provides in some embodiments an access processing method. A target NAS message includes a first NAS message corresponding to a first network and a second NAS message corresponding to a second network. As shown in FIG. 10, the access processing method includes: Step 308 of selecting the first NAS message and the second NAS message corresponding to the second network as the target NAS message; Step 302 of transmitting an access request carrying the target NAS message to a base station, so that the base station transmits the target NAS message to a target core network, the target core network being a core network to which the base station is capable of accessing among a first core network corresponding to the first network and a second core network corresponding to the second network; Step 303 of receiving a response message from the target core network through the base station; and Step 309 of determining the target core network to the accessed in accordance with a format of the response message.

Detailed description will be given as follows.

When there are two target NAS messages, a processing procedure will be described as follows. The mobile communication terminal may transmit the access request carrying both the first NAS message and the second NAS message. Upon the receipt of the access request, the base station may randomly select the target core network. The target core network may process one of the first NAS message and the second NAS message in accordance with the network corresponding to the target core network, and return the response message to the mobile communication terminal. The mobile communication terminal may then determine the target core network to be accessed in accordance with the format of the response message.

For the LTE eNB, it may merely forward the NAS message to the EPC. Upon the receipt of the access request, the EPC may perform security authentication on the mobile communication terminal in accordance with the first NAS message. Upon the receipt of the NAS message, when the mobile communication terminal determines that the NAS message is in an EPC format, the mobile communication terminal may access to the EPC through the LTE eNB, and the subsequent interaction may be performed in accordance with the EPC NAS message.

For the eLTE eNB, it may forward the NAS message from the mobile communication terminal to the EPC or the 5G new core network. Upon the receipt of the access request, the EPC or the 5G new core network may perform the security authentication on the mobile communication terminal in accordance with the corresponding NAS message. Upon the receipt of the NAS message, when the mobile communication terminal determines that the NAS message is in the EPC format, the mobile communication terminal may access to the EPC through the eLTE eNB, and the subsequent interaction may be performed in accordance with the EPC NAS message. When the NAS message is in a 5G Core Network (CN) format, the mobile communication terminal may access to the 5G CN, and the subsequent interaction may be performed in accordance with the 5G CN NAS message.

The present disclosure further provides in some embodiments a base station which, as shown in FIG. 11, includes: a first reception module configured to receive an access request carrying a target NAS message from a mobile communication terminal capable of being connected to a first network and a second network, the target NAS message including a first NAS message corresponding to the first network and/or a second NAS message corresponding to the second network; a first selection module configured to determine a target core network, the target core network being a core network to which the base station is capable of accessing among a first core network corresponding to the first network and a second core network corresponding to the second network; and a first transmission module configured to transmit the target NAS message to the target core network.

Of course, in order to ensure the access procedure, in some embodiments of the present disclosure, the base station may further include: a second reception module configured to receive an access rejection message from the target core network when a network corresponding to the target NAS message is different from a network corresponding to the target core network; and a second transmission module configured to transmit the access rejection message to the mobile communication terminal and notify the mobile communication terminal to re-initiate an access procedure in accordance with a new NAS message.

In order to prevent the access failure, in some embodiments of the present disclosure, the base station may further include a third transmission module configured to transmit network information indicating a network corresponding to the core network to which the base station is capable of being connected, so as to enable the mobile communication terminal to select an NAS message for the network corresponding to the core network to which the base station is capable of being connected from the first NAS message and the second NAS message as the target NAS message in accordance with the network information.

In order to further prevent the re-access procedure, in some embodiments of the present disclosure, a network identity of a network corresponding to the target NAS message may be further carried in the access request. The first selection module is further configured to determine a core network corresponding to the network indicated by the network identity as the target core network. The third transmission module is further configured to transmit the network information through an SIB or RRC signaling.

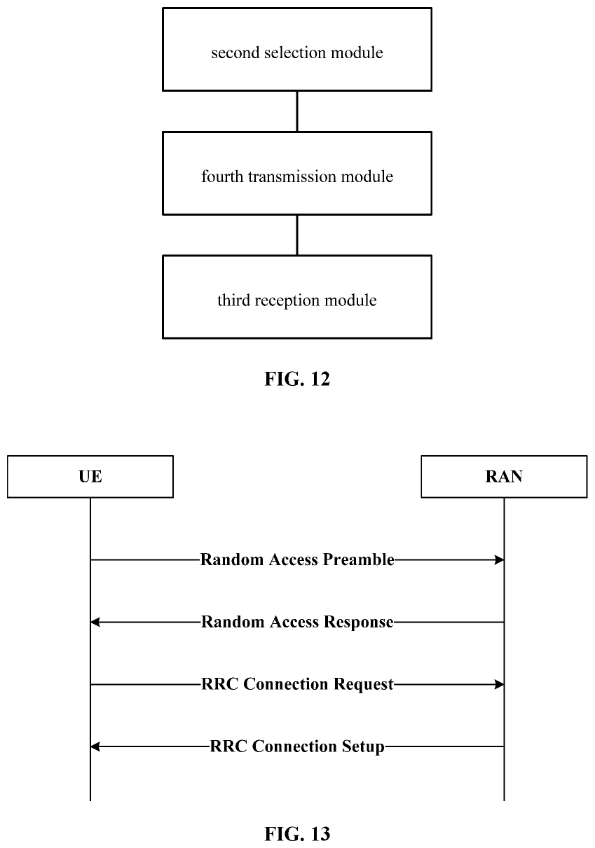

The present disclosure further provides in some embodiments a mobile communication terminal capable of being connected to a first network and a second network, which, as shown in FIG. 12, includes: a second selection module configured to select a target NAS message, the target NAS message including a first NAS message corresponding to the first network and/or a second NAS message corresponding to the second network; a fourth transmission module configured to transmit an access request carrying the target NAS message to a base station, so that the base station transmits the target NAS message to a target core network, the target core network being a core network to which the base station is capable of accessing among a first core network corresponding to the first network and a second core network corresponding to the second network; and a third reception module configured to receive a response message from the target core network through the base station.

Of course, in order to ensure an access procedure, in some embodiments of the present disclosure, the mobile communication terminal may further include a re-access module configured to, when the response message is an access rejection message indicating that a network corresponding to the target NAS message is different from a network corresponding to the target core network, select an NAS message different from the target NAS message from the first NAS message and the second NAS message as a new target NAS message, and re-initiate an access procedure.

In order to prevent the access failure, in some embodiments of the present disclosure, the mobile communication terminal may further include a fourth reception module configured to receive network information from the base station, and the network information indicates a network corresponding to the core network to which the base station is capable of being connected. The second selection module is further configured to select an NAS message for the network corresponding to the core network to which the base station is capable of being connected from the first NAS message and the second NAS message as the target NAS message in accordance with the network information.

In some embodiments of the present disclosure, in order to further prevent the re-access procedure, a network identity of a network corresponding to the target NAS message may be further carried in the access request, so as to enable the base station to determine a core network corresponding to the network indicated by the network identity as the target core network.

The fourth reception module is further configured to receive the network information through an SIB or RRC signaling.

In order to prevent the re-access procedure, in some embodiments of the present disclosure, the target NAS message may include the first NAS message corresponding to the first network and the second NAS message corresponding to the second network. The mobile communication terminal may further include a target core network determination module configured to determine the target core network in accordance with a network corresponding to the response message.

Detailed description will be given as follows when the first network is a 4G mobile communication network and the second network is a 5G mobile communication network.

When there is merely one target NAS message, the following circumstances may be involved.

1. The target NAS message is an NAS message corresponding to the 4G mobile communication network, the base station is an LTE eNB in a 4G mobile communication system, and the target core network is an EPC corresponding to the 4G mobile communication network.

2. The target NAS message is an NAS message corresponding to the 4G mobile communication network, the base station is an eLTE eNB in a 5G mobile communication system, and the target core network is the EPC corresponding to the 4G mobile communication network.

3. The target NAS message is an NAS message corresponding to the 4G mobile communication network, the base station is the eLTE eNB in a 5G mobile communication system, and the target core network is a 5G CN corresponding to the 5G mobile communication network.

4. The target NAS message is an NAS message corresponding to the 5G mobile communication network, the base station is the LTE eNB in the 4G mobile communication system, and the target core network is the EPC corresponding to the 4G mobile communication network.

5. The target NAS message is an NAS message corresponding to the 5G mobile communication network, the base station is the eLTE eNB in a 5G mobile communication system, and the target core network is the EPC corresponding to the 4G mobile communication network.

6. The target NAS message is an NAS message corresponding to the 5G mobile communication network, the base station is the eLTE eNB in a 5G mobile communication system, and the target core network is the 5G CN corresponding to the 5G mobile communication network.

The above-mentioned six circumstances are all possible combinations when the target NAS message and the target core network are selected randomly.

In the first, second and sixth circumstances, the network corresponding to the target NAS message is the same as the network corresponding to the target core network, so the mobile communication terminal may access to the target core network successfully.

In the third, fourth and fifth circumstances, the network corresponding to the target NAS message is different from the network corresponding to the target core network, so the mobile communication terminal may not access to the target core network successfully for the first time. At this time, the mobile communication terminal needs to select a new target NAS message such that a network corresponding to the new target NAS message is the same as the network corresponding to the target core network, so as to access to the target core network successfully.

When the base station notifies the mobile communication terminal of the network information about the network corresponding to the core network to which the base station is capable of being connected, the mobile communication terminal may select the NAS message for the network corresponding to the core network to which the base station is capable of being connected during the initiation of the access procedure. At this time, the above six circumstances may be reduced to five circumstances, i.e., the fourth circumstance, in which it is necessary to re-initiate the access procedure, may not exist.

The network information may be transmitted in conjunction with an access procedure in FIG. 13. For example, it may be notified to the mobile communication terminal through an SIB message or through RRC signaling or RRC connection setup signaling from the base station in an initial access procedure as shown in FIG. 12.

When the base station notifies the mobile communication terminal of the network information about the network corresponding to the core network to which the base station is capable of being connected, the mobile communication terminal may select the NAS message for the network corresponding to the core network to which the base station is capable of being connected during the initiation of the access procedure. At this time, when the network identity of the network corresponding to the target NAS message is further carried in the access request the above six circumstances may be reduced to three circumstances, i.e., the third, fourth and fifth circumstance, in which it is necessary to re-initiate the access procedure, may not exist.

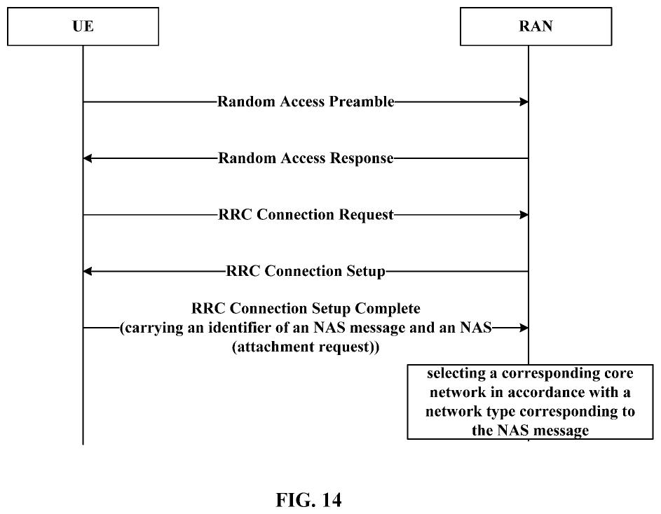

In the above circumstances, the mobile communication terminal may directly carry the NAS message, as well as an identifier of the NAS message, in an attachment request message carried in an RRC connection setup completion message, as shown in FIG. 14. A network element (e.g., a base station) of a wireless access network may select the corresponding core network in accordance with the identifier of the NAS message.

When there are two target NAS messages, the processing procedure will be described as follows. The mobile communication terminal may transmit the access request carrying both the first NAS message and the second NAS message. Upon the receipt of the access request, the base station may randomly select the target core network. The target core network may process one of the first NAS message and the second NAS message in accordance with the network corresponding to the target core network, and return the NAS message in a corresponding format to the mobile communication terminal. The mobile communication terminal may determine the target core network to be accessed in accordance with the format of the NAS message.

For the LTE eNB, it may merely forward the NAS message to the EPC. Upon the receipt of the access request, the EPC may perform security authentication on the mobile communication terminal in accordance with the first NAS message. Upon the receipt of the NAS message, when the mobile communication terminal determines that the NAS message is in an EPC format, the mobile communication terminal may access to the EPC through the LTE eNB, and the subsequent interaction may be performed in accordance with the EPC NAS message.

For the eLTE eNB, it may forward the NAS message from the mobile communication terminal to the EPC or the 5G new core network. Upon the receipt of the access request, the EPC or the 5G new core network may perform the security authentication on the mobile communication terminal in accordance with the corresponding NAS message. Upon the receipt of the NAS message, when the mobile communication terminal determines that the NAS message is in the EPC format, the mobile communication terminal may access to the EPC through the eLTE eNB, and the subsequent interaction may be performed in accordance with the EPC NAS message. When the NAS message is in the 5G CN format, the mobile communication terminal may access to the 5G CN, and the subsequent interaction may be performed in accordance with the 5G CN NAS message.

It should be appreciated that, such terms as “include” or “including” or any other variations involved in the present disclosure intend to provide non-exclusive coverage, so that a procedure, method, article or device including a series of elements may also include any other elements not listed herein, or may include any inherent elements of the procedure, method, article or device. If without any further limitations, for the elements defined by such sentence as “including one . . . ”, it is not excluded that the procedure, method, article or device including the elements may also include any other identical elements.

The serial numbers of the embodiments are for illustrative purposes only, and none of them is superior to the others.

Through the above-mentioned description, it may be apparent for a person skilled in the art that the present disclosure may be implemented by hardware, or by software as well as a necessary common hardware platform. Based on this understanding, the technical solutions of the present disclosure may appear in the form of software products, which may be stored in a storage medium (Read-Only Memory (ROM), Random Access Memory (RAM), magnetic disc or optical disk) and include several instructions so as to enable a terminal device (mobile phone, computer, server, air conditioner or network equipment) to execute the methods according to the embodiments of the present disclosure.

It should be further appreciated that, the device and method may be implemented in any other ways. For example, the embodiments for the apparatus are merely for illustrative purposes, and the modules or units are provided merely on the basis of their logic functions. During the actual application, some modules or units may be combined together or integrated into another system. Alternatively, some functions of the module or units may be omitted or not executed. In addition, the coupling connection, direct coupling connection or communication connection between the modules or units may be implemented via interfaces, and the indirect coupling connection or communication connection between the modules or units may be implemented in an electrical or mechanical form or in any other form.

In addition, the functional units in the embodiments of the present disclosure may be integrated into a processing unit, or the functional units may exist independently, or two or more functional units may be combined together. These units may be implemented in the form of hardware, or hardware plus software.

The present disclosure has been described with reference to the flow charts and/or block diagrams of the method, device (system) and computer program product according to the embodiments of the present disclosure. It should be understood that computer program instructions may be used to implement each of the work flows and/or blocks in the flow charts and/or the block diagrams, and the combination of the work flows and/or blocks in the flow charts and/or the block diagrams. These computer program instructions may be provided to a processor of a common computer, a dedicate computer, an embedded processor or any other programmable data processing devices to create a machine, so that instructions executable by the processor of the computer or the other programmable data processing devices may create a device to achieve the functions assigned in one or more work flows in the flow chart and/or one or more blocks in the block diagram.

These computer program instructions may also be stored in a computer readable storage that may guide the computer or the other programmable data process devices to function in a certain way, so that the instructions stored in the computer readable storage may create a product including an instruction unit which achieves the functions assigned in one or more flows in the flow chart and/or one or more blocks in the block diagram.

These computer program instructions may also be loaded in the computer or the other programmable data process devices, so that a series of operation steps are executed on the computer or the other programmable devices to create processes achieved by the computer. Therefore, the instructions executed in the computer or the other programmable devices provide the steps for achieving the function assigned in one or more flows in the flow chart and/or one or more blocks in the block diagram.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. An access processing method for use in a base station, comprising:
receiving an access request carrying a target Non-Access Stratum (NAS) message from a mobile communication terminal capable of being connected to a first network and a second network, the target NAS message comprising a first NAS message corresponding to the first network and/or a second NAS message corresponding to the second network;
determining a target core network, the target core network being a core network to which the base station is capable of accessing among a first core network corresponding to the first network and a second core network corresponding to the second network; and
transmitting the target NAS message to the target core network.

2. The access processing method according to claim 1, further comprising:
receiving an access rejection message from the target core network when a network corresponding to the target NAS message is different from a network corresponding to the target core network; and
transmitting the access rejection message to the mobile communication terminal and notifying the mobile communication terminal to re-initiate an access procedure in accordance with a new NAS message.

3. The access processing method according to claim 1, further comprising:
transmitting network information indicating a network corresponding to the core network to which the base station is capable of being connected, so as to enable the mobile communication terminal to select an NAS message for the network corresponding to the core network to which the base station is capable of being connected from the first NAS message and the second NAS message as the target NAS message in accordance with the network information.

4. The access processing method according to claim 3, wherein a network identity of a network corresponding to the target NAS message is further carried in the access request, and the determining the target core network comprises determining a core network corresponding to the network indicated by the network identity as the target core network.

5. The access processing method according to claim 3, wherein the transmitting the network information about the network corresponding to the core network to which the base station is capable of being connected comprises:
transmitting the network information through a System Information Block (SIB) or Radio Resource Control (RRC) signaling.

6. An access processing method for use in a mobile communication terminal capable of being connected to a first network and a second network, comprising:
selecting a target NAS message, the target NAS message comprising a first NAS message corresponding to the first network and/or a second NAS message corresponding to the second network;
transmitting an access request carrying the target NAS message to a base station, so that the base station transmits the target NAS message to a target core network, the target core network being a core network to which the base station is capable of accessing among a first core network corresponding to the first network and a second core network corresponding to the second network; and
receiving a response message from the target core network through the base station.

7. The access processing method according to claim 6, further comprising:
when the response message is an access rejection message indicating that a network corresponding to the target NAS message is different from a network corresponding to the target core network, selecting an NAS message different from the target NAS message from the first NAS message and the second NAS message as a new target NAS message, and re-initiating an access procedure.

8. The access processing method according to claim 6, further comprising:
receiving network information from the base station, the network information indicating a network corresponding to the core network to which the base station is capable of being connected, wherein the selecting the target NAS message comprises selecting an NAS message for the network corresponding to the core network to which the base station is capable of being connected from the first NAS message and the second NAS message as the target NAS message in accordance with the network information.

9. The access processing method according to claim 8, wherein a network identity of a network corresponding to the target NAS message is further carried in the access request, so as to enable the base station to determine a core network corresponding to the network indicated by the network identity as the target core network.

10. The access processing method according to claim 8, wherein the receiving the network information from the base station comprises receiving the network information through an SIB or RRC signaling.

11. The access processing method according to claim 6, wherein the target NAS message comprises the first NAS message corresponding to the first network and the second NAS message corresponding to the second network, and the access processing method further comprises determining the target core network in accordance with a network corresponding to the response message.

12-22. (canceled)

23. A base station, comprising a processor, a transceiver and a memory,
wherein the processor is configured to read a program stored in the memory, so as to: receive an access request carrying a target NAS message from a mobile communication terminal capable of being connected to a first network and a second network, the target NAS message comprising a first NAS message corresponding to the first network and/or a second NAS message corresponding to the second network; determine a target core network, the target core network being a core network to which the base station is capable of accessing among a first core network corresponding to the first network and a second core network corresponding to the second network; and transmit the target NAS message to the target core network,
wherein the transceiver is configured to receive and transmit data,
wherein the memory is configured to store therein data for the operation of the processor.

24. A mobile communication terminal capable of being connected to a first network and a second network, comprising a processor, a transceiver and a memory, wherein the processor is configured to read a program stored in the memory, so as to: select a target NAS message, the target NAS message comprising a first NAS message corresponding to the first network and/or a second NAS message corresponding to the second network; transmit an access request carrying the target NAS message to a base station, so that the base station transmits the target NAS message to a target core network, the target core network being a core network to which the base station is capable of accessing among a first core network corresponding to the first network and a second core network corresponding to the second network; and receive a response message from the target core network through the base station,
wherein the transceiver is configured to receive and transmit data,
wherein he memory is configured to store therein data for the operation of the processor.

25-26. (canceled)

27. The base station according to claim 23, the processor is further configured to:
receive an access rejection message from the target core network when a network corresponding to the target NAS message is different from a network corresponding to the target core network; and
transmit the access rejection message to the mobile communication terminal and notifying the mobile communication terminal to re-initiate an access procedure in accordance with a new NAS message.

28. The base station according to claim 23, the processor is further configured to:
transmit network information indicating a network corresponding to the core network to which the base station is capable of being connected, so as to enable the mobile communication terminal to select an NAS message for the network corresponding to the core network to which the base station is capable of being connected from the first NAS message and the second NAS message as the target NAS message in accordance with the network information.

29. The base station according to claim 28, wherein a network identity of a network corresponding to the target NAS message is further carried in the access request, and the determining the target core network comprises determining a core network corresponding to the network indicated by the network identity as the target core network.

30. The base station according to claim 28, wherein the processor is further configured to:
transmit the network information through a System Information Block (SIB) or Radio Resource Control (RRC) signaling.

31. The mobile communication terminal according to claim 24, the processor is further configured to:
when the response message is an access rejection message indicating that a network corresponding to the target NAS message is different from a network corresponding to the target core network, select an NAS message different from the target NAS message from the first NAS message and the second NAS message as a new target NAS message, and re-initiating an access procedure.

32. The mobile communication terminal according to claim 24, the processor is further configured to:
receive network information from the base station, the network information indicating a network corresponding to the core network to which the base station is capable of being connected, wherein the selecting the target NAS message comprises selecting an NAS message for the network corresponding to the core network to which the base station is capable of being connected from the first NAS message and the second NAS message as the target NAS message in accordance with the network information.

33. The mobile communication terminal according to claim 32, wherein a network identity of a network corresponding to the target NAS message is further carried in the access request, so as to enable the base station to determine a core network corresponding to the network indicated by the network identity as the target core network;
wherein the receiving the network information from the base station comprises receiving the network information through an SIB or RRC signaling; and
wherein the target NAS message comprises the first NAS message corresponding to the first network and the second NAS message corresponding to the second network, and the access processing method further comprises determining the target core network in accordance with a network corresponding to the response message.
